(19) United States
(12) Patent Application Publication
(10) Pub. No.: US 2002/0105201 A1
(43) Pub. Date: Aug. 8, 2002

(54) Integrated extendable load floor assembly for vehicles

(76) Inventors: Joseph John Melotik, Dearborn, MI (US); Jerry Edward Pack, Pinckney, MI (US); Makonnen W. Eyob, Canton, MI (US); Maria Glavanovich, Canton, MI (US); William Francis McAtamney, West Bloomfield, MI (US)

Correspondence Address: BLISS MCGLYNN & NOLAN, P.C., 2075 WEST BIG BEAVER ROAD, SUITE 600, TROY, MI, 48084, US

(21) Appl. No.: 09/681,166

(22) Filed: Feb. 7, 2001

(51) Int. Cl. B62D 33/08

(52) U.S. Cl. 296/26.09; 296/37.1

(57) ABSTRACT

20An integrated extendable load floor assembly is provided for a vehicle having a rear end with a floor and sides extending upwardly and along the floor to form a cargo area and a decklid for closing an upper portion of the cargo area. The integrated extendable load floor assembly includes a plurality of rails adapted to be to be disposed upon the sides above the floor of the rear end. The integrated drawer assembly also includes a load floor operatively cooperating with the rails for sliding movement therealong and to close a longitudinal end of the cargo area.

### BACKGROUND OF INVENTION

The present invention relates generally to vehicles and, more specifically, to an integrated extendable load floor assembly for a vehicle.

It is known to provide a rear end for a vehicle such as a sedan type automotive vehicle. Typically, the vehicle body has a rear end with a cargo or trunk area and is closed at an upper portion thereof by a trunk lid or decklid. The decklid is hinged to the body of the vehicle to have an up or open position to open the cargo area and a down or closed position to close the cargo area.

It is desirable to expand a carrying capability of the cargo area in a conventional sedan type automotive vehicle without compromising an exterior appearance of the vehicle. It is also desirable to provide an extendable load floor assembly for a sedan type automotive vehicle to aid in carrying large or oversize objects. It is further desirable to provide an extendable load floor assembly that is integrated with a rear end of a vehicle.

### SUMMARY OF INVENTION

Accordingly, the present invention is an integrated extendable load floor assembly for a vehicle having a rear end with a floor and sides extending upwardly and along the floor to form a cargo area and a decklid for closing an upper portion of the cargo area. The integrated extendable load floor assembly includes a plurality of rails adapted to be to be disposed upon the sides above the floor of the rear end. The integrated extendable load floor assembly also includes a load floor operatively cooperating with the rails for sliding movement therealong and to close a longitudinal end of the cargo area.

One advantage of the present invention is that an integrated extendable load floor assembly is provided for a vehicle such as a sedan type automotive vehicle. Another advantage of the present invention is that the integrated extendable load floor assembly provides expanded carrying capability of the cargo area in a conventional sedan type automotive vehicle without compromising the exterior appearance of the vehicle and integrated with the rear end of the vehicle. Yet another advantage of the present invention is that the integrated extendable load floor assembly allows the cargo area to expand to carry long or tall items that previously could not be accommodated in a conventional sedan type automotive vehicle. Still another advantage of the present invention is that the integrated extendable load floor assembly has a decklid that minimizes the lift over height required to load items in the cargo area of the rear end of the vehicle.

Other features and advantages of the present invention will be readily appreciated, as the same becomes better understood, after reading the subsequent description when taken in conjunction with the accompanying drawings.

### BRIEF DESCRIPTION OF DRAWINGS

FIG. 1 is a perspective view of an integrated extendable load floor assembly, according to the present invention, illustrated in operational relationship with a vehicle.

FIG. 2 is a view similar to FIG. 1 of the integrated extendable load floor assembly illustrated in an open position.

FIG. 3 is a side elevational view of the integrated extendable load floor assembly of FIG. 1 illustrated in an open position.

FIG. 4 is an enlarged perspective view of the integrated extendable load floor assembly of FIG. 3 illustrating an endgate in an open position.

FIG. 5 is a perspective view of a portion of the integrated extendable load floor assembly of FIG. 1.

FIG. 6 is an enlarged perspective view of the integrated extendable load floor assembly of FIG. 3 illustrating an inner panel of a floor in an open position.

FIG. 7 is an enlarged perspective view of a portion of the integrated extendable load floor assembly of FIG. 6 illustrating the endgate in an open position.

FIG. 8 is an enlarged elevational view of a portion of the endgate of the integrated extendable load floor assembly of FIG. 3.

FIG. 9 is an enlarged perspective view of a portion of the integrated extendable load floor assembly of FIG. 3.

FIG. 10 is a perspective view of the integrated extendable load floor assembly of FIG. 3 illustrating an inner panel of an endgate in an open position.

FIG. 11 is a perspective view of the integrated extendable load floor assembly of FIG. 3 illustrating the endgate in an open position with an optional endgate extender.

### DETAILED DESCRIPTION

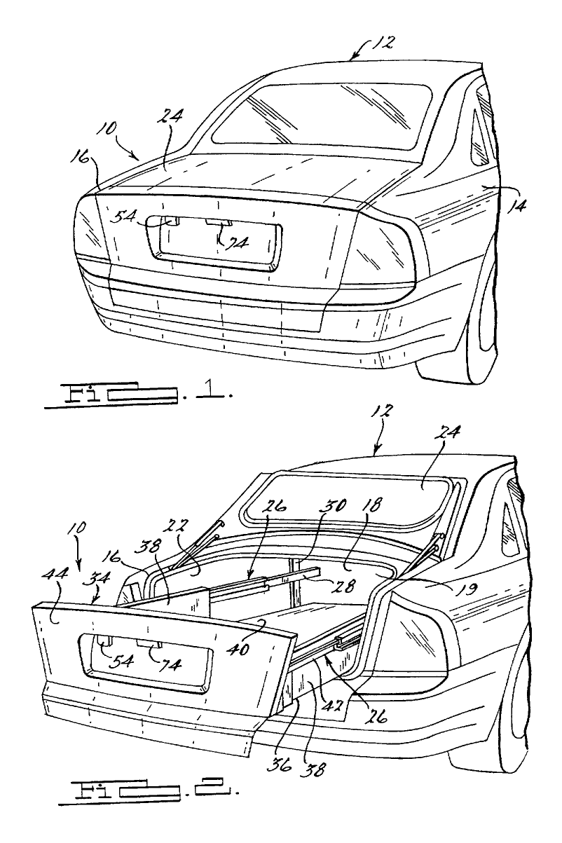

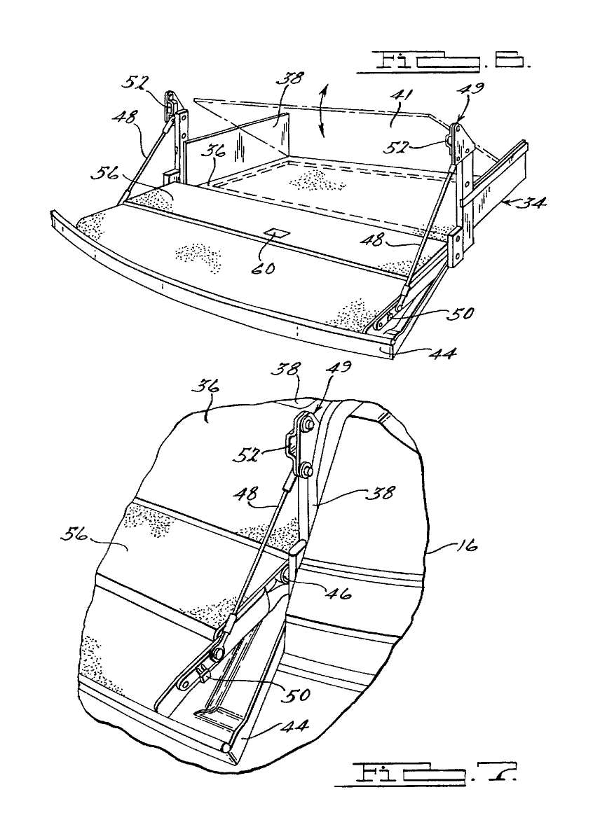

Referring now to the drawings and in particular FIGS. 1 and 2, one embodiment of an integrated extendable load floor assembly 10, according to the present invention, is illustrated in connection with a vehicle, generally indicated at 12, such as a sedan type automotive vehicle 12. Such vehicles 12 typically include a body 14 having a rear end 16 forming a storage or cargo area 18. The rear end 16 includes a front 19, floor 20 (FIG. 5), two sides 22 and a rear decklid 24, which define the cargo area 18. The vehicle 12 also includes the integrated extendable load floor assembly 10 disposed in and closing a longitudinal end of the cargo area 18. It should be appreciated that the decklid 24 may be removable. It should also be appreciated that, except for the integrated extendable load floor assembly 10, the vehicle 12 is conventional and known in the art.

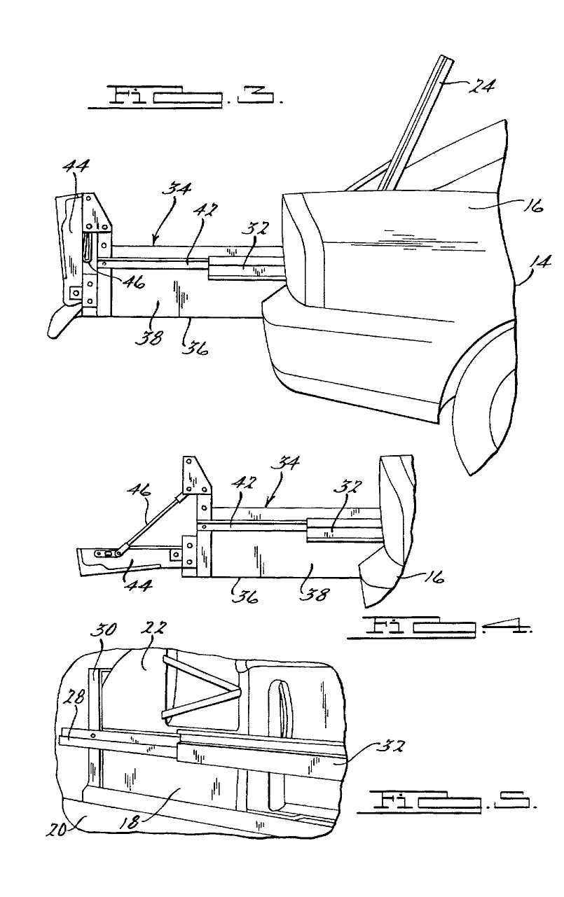

Referring to FIGS. 2 through 6, the integrated extendable load floor assembly 10 includes a plurality of, preferably a pair of rails, generally indicated at 26, spaced laterally and extending longitudinally between the sides 22 above the floor 20 of the rear end 16. Each of the rails 26 has a first rail member 28 extending longitudinally and at least one first bracket member 30 for attaching the first rail member 28 to the sides 22. The first rail member 28 is attached to the first bracket member 30 by suitable means such as fasteners (not shown) or welding and the first bracket member 30 is attached to the sides 22 by suitable means such as fasteners (not shown) or welding. It should be appreciated that the first rail member 28 is stationary relative to the body 14 of the vehicle 12.

Each of the rails 26 has a second rail member 32 slidably connected to the first rail member 28. The second rail member 32 cooperates with the first rail member 28 to allow at least a portion of the second rail member 32 to extend beyond the first rail member 28 for a function to be described. The rails 26 may each include a stop member (not shown) attached to either one of the first rail member 28 or second rail member 32 to limit the longitudinal extension of the second rail member 32 relative to the first rail member 28. The rails 26 are made of a rigid material such as metal. It should be appreciated that the rails 26 are conventional and known in the art.

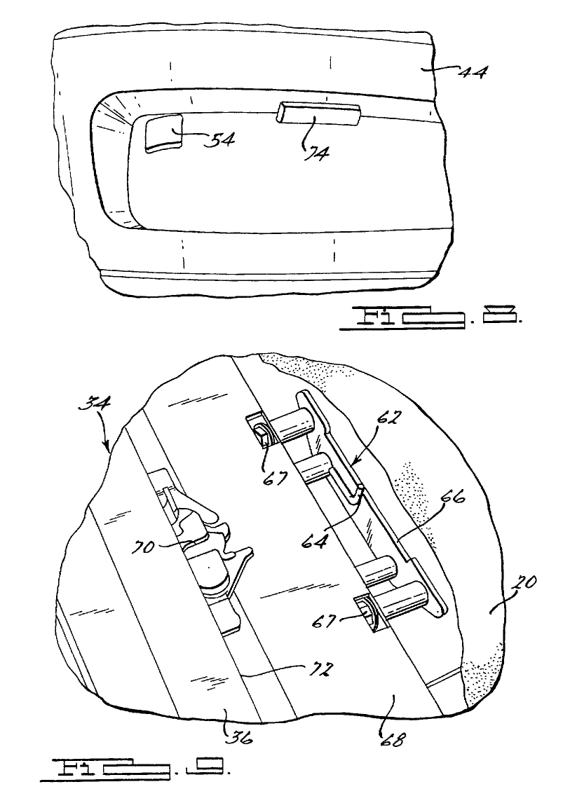

Referring to FIGS. 2 through 10, the integrated extendable load floor assembly 10 also includes at least one drawer or load floor, generally indicated at 34, for cooperating with the rails 26. The load floor 34 has a bottom 36 and opposed sides 38 extending generally perpendicular to the bottom 36 to form a cavity or chamber 40 therein with open longitudinal ends. The load floor 34 is generally rectangular in shape. The load floor 34 is made of a rigid material such as metal. It should be appreciated that the load floor 34 is used to hold objects or cargo such as luggage therein.

The load floor 34 may include an inner panel 41 that is pivotally connected to a forward interior end thereof by suitable means such as a hinge (not shown) and movable relative thereto to allow access to a spare tire (not shown) to be stored within a recess (not shown) of the floor 20 of the rear end 16 as illustrated in FIG. 6. The inner panel 41 may include a latch mechanism (not shown) on the inner panel 41 to releasably secure the inner panel 41 to the bottom 36 of the load floor 34.

The load floor 34 also includes a slide 42 disposed on and attached to the sides 38 thereof. The slides 42 extend longitudinally and cooperate with the second rail member 32 of the rails 26 for sliding therealong. The load floor 34 may include a stop member (not shown) attached to either one of the slide 42 or second rail member 32 to limit the longitudinal extension of the slide 42 relative to the second rail member 32. The slide 42 is attached to the side 38 of the load floor 34 by suitable means such as fasteners (not shown) or welding. It should be appreciated that the slide 42 is conventional and known in the art. It should also be appreciated that the slide 42 is stationary relative to the load floor 34, but is movable relative to the second rail member 32, first rail member 28, and body 14 of the vehicle 12.

The integrated extendable load floor assembly 10 also includes a rear panel or endgate 44 to close a rear longitudinal open end of the load floor 34. The endgate 44 is generally rectangular in shape. The endgate 44 is pivotally connected to the sides 38 of the load floor 34 by suitable means such as a pivot pin 46 at a lower end thereof. The endgate 44 is also connected to the sides 38 of the load floor 34 by suitable means such as a cable 48 at an upper end thereof. It should be appreciated that the endgate 44 has an upper latch mechanism (not shown) to cooperate with the decklid 24 for releasably latching the decklid 24 to the endgate 44 when the endgate 44 is in a closed upright position.

The integrated extendable load floor assembly 10 includes a latch mechanism, generally indicated at 49, to latch the endgate 44 in a closed position relative to the load floor 34. The latch mechanism 49 has a striker 50 on each lateral side of the endgate 44 and a latch 52 on each lateral side 38 of the drawer 34 for engaging and disengaging the striker 50. The latch mechanism 49 also includes a movable handle 54 for actuating the latch 52 to release the striker 50 to move the endgate 44 from a closed and generally vertical position to an open and generally horizontal position. It should be appreciated that the pivot pin 46, striker 50, and latch 52 are conventional and known in the art.

The endgate 44 may include an inner panel 56 that is pivotally connected to a lower interior end thereof by suitable means such as a hinge (not shown) and movable relative thereto to allow objects (not shown) to be stored within an interior cavity 58 of the endgate 44 as illustrated in FIG. 10. The endgate 44 may include a latch mechanism 60 on the inner panel 54 to releasably secure the inner panel 56 to the endgate 44.

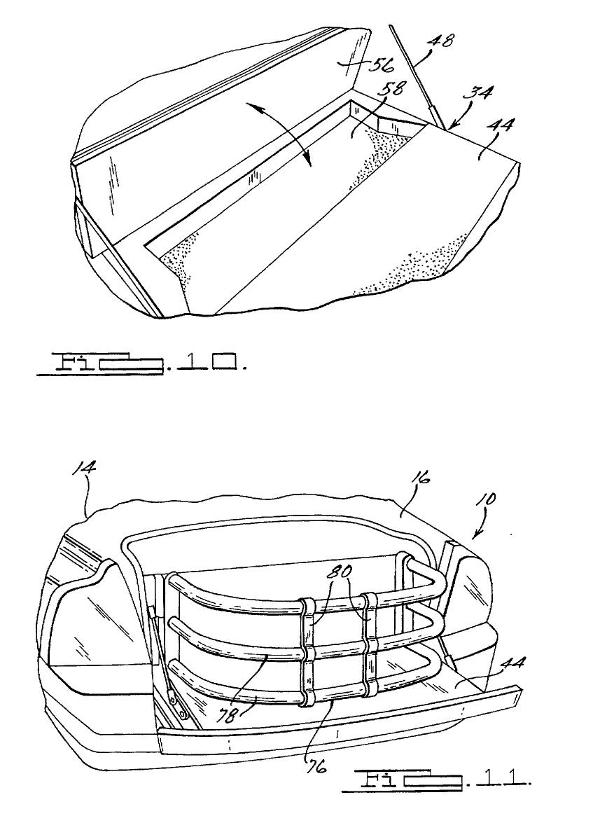

As illustrated in FIGS. 8 and 9, the integrated extendable load floor assembly 10 includes a latch mechanism, generally indicated at 62, to latch the drawer 34 in a closed position relative to the rear end 16 of the vehicle 12. The latch mechanism 62 includes a striker 64 attached by suitable means such as a bracket 66 to a rear bumper 68 on adjacent the floor 20 of the rear end 16. The bracket 66 is attached to the rear bumper 68 by suitable means such as fasteners 67 or welding. The latch mechanism 62 also includes a latch 70 attached by suitable means such as fasteners (not shown) to a forward longitudinal end 72 of the bottom 26 of the drawer 34 for engaging and disengaging the striker 64. The latch mechanism 62 includes a movable handle 74 for actuating the latch 70 to release the striker 64 to move the drawer 60 from a closed position adjacent to the rear end 16 of the vehicle 12 to an open position spaced longitudinally away from the rear end 16 of the vehicle 12. It should be appreciated that the striker 64 and latch 70 are conventional and known in the art.

Referring to FIG. 11, the integrated extendable load floor assembly 10 may include an endgate extender 76 attached to the sides 38 of the load floor 34. The endgate extender 76 has a plurality of tubes 78 spaced vertically and extending laterally and interconnected by a plurality of straps 80 extending vertically and spaced laterally. The endgate extender 76 is disposed on the endgate 44 when the endgate 44 is in the open position and connected to the sides 38 of the load floor 34 by suitable means such as fasteners (not shown). It should be appreciated that the drawer 34 is in the closed position and the endgate 44 is in the open position when the endgate extender 76 is attached to the load floor 34. It should also be appreciated that the endgate extender 76 is optional.

In another embodiment, the integrated extendable load floor assembly 10 may eliminate the extendable load floor 34 and have the endgate 44 pivotally connected to the sides 22 of the rear end 16. In this embodiment, the endgate 44 includes the latch mechanism 49 to latch the endgate 44 in a closed upright position relative to the sides 22 of the rear end 16 and an upper latch mechanism (not shown) to cooperate with the decklid 24 for releasably latching the decklid 24 to the endgate 44 when the endgate 44 is in a closed upright position. It should be appreciated that this embodiment would look similar to that illustrated in FIG. 11 and may include the endgate extender 76.

In operation of the integrated extendable load floor assembly 10, during normal operating conditions, the load floor 34 is in a closed position with the rear end 16 to close the longitudinal end of the cargo area 18 of the rear end 16 as illustrated in FIG. 1. The load floor 34 is used to hold objects in the cargo area 18 of the rear end 16. In addition, the decklid 24 is in a closed position with the rear end 16 to close an upper portion of the cargo area 18.

If desirable, the upper latch mechanism (not shown) may be actuated via a handle (not shown) to allow the decklid 24 to move from a closed position with the rear end 16 to an open position with the rear end 16 as illustrated in FIG. 2. At this point, cargo may be unloaded from the load floor 34 by an operator (not shown) in a conventional manner. If desired, the operator via the handle 74 may actuate the latch mechanism 62, and the load floor 34 may be slid rearward an open position with the rear end 16 as illustrated in FIG. 2 to allow the operator to unload the cargo from the load floor 34. It should be appreciated that the endgate 44 is in a closed position relative to the load floor 34.

If desirable, the latch mechanism 49 may be actuated via the handle 54 to allow the endgate 44 to move from a closed position with the drawer 34 to an open position with the drawer 34 as illustrated in FIG. 4. At this point, cargo may be unloaded from the load floor 34. If desired, the latch mechanism 60 may be actuated by the operator and the inner panel 56 of the endgate 44 moved upward to an open position with the endgate 44 as illustrated in FIG. 10 to allow the operator to unload the cargo from the cavity 58 of the endgate 44. If desired, the latch mechanism (not shown) may be actuated by the operator and the inner panel 41 of the load floor 34 moved upward to an open position with the bottom 36 of the load floor 34 as illustrated in FIG. 6 to allow the operator access to the spare tire (not shown) in the recess (not shown) of the floor 20 of the rear end 16. It should be appreciated that the endgate 44 is in an open position relative to the load floor 34.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. An integrated extendable load floor assembly for a vehicle having a rear end with a floor and sides extending upwardly and along the floor to form a cargo area and a decklid for closing an upper portion of the cargo area, said integrated drawer assembly comprising:
a plurality of rails adapted to be disposed upon the sides above the floor of the rear end; and
a load floor operatively cooperating with said rails for sliding movement therealong and to close a longitudinal end of the cargo area.

2. An integrated extendable load floor assembly as set forth in claim 1 including a pair of slides disposed on opposed sides of said load floor and cooperating with said rails.

3. An integrated extendable load floor assembly as set forth in claim 1 wherein said load floor comprises a bottom and sides extending generally perpendicular to said bottom to form a compartment for holding objects.

4. An integrated extendable load floor assembly as set forth in claim 1 including an endgate pivotally attached to a rear longitudinal end of said load floor having an upright closed position and a horizontal open position.

5. An integrated extendable load floor assembly as set forth in claim 4 including a latching mechanism to latch said endgate to said load floor in said upright closed position.

6. An integrated drawer assembly as set forth in claim 1 including a latching mechanism to latch said load floor in a closed position with the rear end of the vehicle.

7. An integrated extendable load floor assembly as set forth in claim 1 wherein said load floor includes an inner panel pivotally attached thereto to pivot between a closed position and an open position relative to a bottom thereof.

8. An integrated extendable load floor assembly for a vehicle having an enclosed integral rear storage area comprising:
at least one rail adapted to be disposed upon the bottom of the rear storage area; and
a load floor cooperating with said at least one rail allowing for a selective sliding movement in and out of the rear storage area of the vehicle.

9. An integrated extendable load floor assembly as set forth in claim 8 including at least one slide disposed on sides of said load floor and cooperating with a portion of said at least one rail.

10. An integrated extendable load floor assembly as set forth in claim 8 wherein said load floor comprises a bottom and sides extending generally perpendicular to said bottom to form a compartment for holding objects.

11. An integrated extendable load floor assembly as set forth in claim 8 including a rear panel that is cooperatively attached to a bottom of a rear edge of said load floor allowing selective positioning of the said rear panel in an upright closed position and a lower horizontal open position.

12. An integrated extendable load floor assembly as set forth in claim 11 including a rear panel latching mechanism that latches said rear panel in said upright closed position.

13. An integrated extendable load floor assembly as set forth in claim 11 including a load floor latching mechanism that latches said load floor in a closed position within said storage area.

14. A vehicle comprising:
a rear storage area having a longitudinal open end; and
an integrated extendable load floor assembly cooperating with said rear storage area for allowing selective sliding movement in and out of said rear storage area of the vehicle and to close said open end of said rear storage area.

15. A vehicle as set forth in claim 14 wherein said integrated extendable load floor assembly includes at least one rail connected to said rear storage area and a load floor cooperating with said at least one rail for sliding movement therealong.

16. A vehicle as set forth in claim 15 wherein said load floor comprises a bottom and sides extending generally perpendicular to said bottom to form a compartment for holding objects.

17. A vehicle as set forth in claim 15 including a rear panel that is cooperatively attached to a bottom of a rear edge of said load floor allowing selective positioning of the said rear panel in an upright closed position and a horizontal open position.

18. A vehicle as set forth in claim 17 including a rear panel latching mechanism that latches said rear panel in said upright closed position.

19. A vehicle as set forth in claim 17 including a load floor latching mechanism that latches said load floor in a closed position with said rear storage area.

20. An automotive vehicle comprising:
a body including a rear end having a floor and sides extending upwardly and along said floor to form a cargo area;
a plurality of rails spaced laterally and extending longitudinally between said sides above said floor;
a load floor operatively cooperating with said rails for sliding movement therealong; and
a decklid pivotally secured to said sides to cover said cargo area in a closed position and to allow access to said cargo area in an open position and to allow said load floor to be extended when said decklid is in said open position.

21. A sedan type automotive vehicle comprising:
a body including a rear end having a floor and sides extending upwardly and along said floor to form a cargo area;
an endgate pivotally connected to said sides having a closed upright position and an open horizontal position; and
a decklid pivotally secured to said sides and cooperating with said endgate to cover said cargo area in a closed position and to allow access to said cargo area in an open position and to allow objects to be removed from said cargo area when said decklid is in said open position.
